(19) United States
(12) Patent Application Publication
(10) Pub. No.: US 2012/0206784 A1
(43) Pub. Date: Aug. 16, 2012

(54) DEVICE FOR REDUCING SPECKLE EFFECT IN A DISPLAY SYSTEM

(75) Inventors: Yick Chuen CHAN, Hong Kong (HK); Siu Wai Lam, Hong Kong (HK); Lo Ming FOK, Hong Kong (HK); Ying LIU, Hong Kong (HK); Chen Jung TSAI, Hong Kong (HK)

(73) Assignee: Hong Kong Applied Science and Technology Research Institute Company Limited, Hong Kong (HK)

(21) Appl. No.: 13/029,112

(22) Filed: Feb. 16, 2011

(51) Int. Cl. G02B 26/10; G02B 27/48; G02B 26/08

(52) U.S. Cl. 359/212.1; 359/196.1

(57) ABSTRACT

The present invention relates to a method and apparatus for speckle noise reduction in laser scanning projection display. In particular, a MEMS device with a vibrating membrane through which light rays are refracted with temporally varying angles is provided for reducing the effect of speckling.

### CROSS REFERENCE TO RELATED PATENT APPLICATION

All the subject matter of the co-pending U.S. patent application entitled “Device for Reducing Speckle Effect in a Display System” filed under the attorney docket number P3448US00 on 16 Feb. 2011 and the entire content thereof is hereby incorporated by reference.

### TECHNICAL FIELD

The present application relates to an apparatus for projecting a digital image in general and, more particularly, to de-speckling devices and methods that can reduce or remove speckle in an image formed by a laser-based projector.

### BACKGROUND

We receive visual information all the time, for example, watching movies. Nowadays, a huge amount of visual information is generated because of the user-friendliness of consumer electronics such as digital cameras. Similarly, there is a huge demand for displays from which we receive visual information. The development of display technology has been fast and the number of different ways to display an image has been increasing, for example, cathode ray tube (CRT) displays, liquid crystal device (LCD) displays, light emitting diode (LED) displays, organic LED (OLED) displays, head-up displays (HUD), laser scanning projection (LSP) displays, and projectors. In the present description, whenever a reference is made to an image, the same will also be applicable to a motion picture which is also known as video.

Human vision is sensitive to noise so that a good image quality without noise is very much appreciated. One type of noise is known as speckles and this sort of speckle noise is particularly common for displays with a coherent light source such as a laser in a display, a HUD or a LSP display. For example, in the case of a projector with a laser as the light source, there will be speckles in the image projected onto a screen due to the laser being reflected by a screen surface as depicted in FIG. 1. When compared with the wavelengths of visible light, the surface of any screen can be regarded as rough and therefore gives rise to scattering. The reflected light rays reaching a viewer's eyes from various independent scattering areas on the screen surface have relative phase differences and interfere with one another, generating granular bright and dark patterns called speckle.

Numerous approaches have been adopted to reduce the speckle by destroying the coherence of the laser beam. If the coherence of the laser beam is destroyed, the speckle can be averaged out because the speckle effects become independent. For N independent speckle patterns, the reduction factor is given by the following equation (1):

R=\sqrt{N} (1)

These approaches include providing angular diversity, wavelength diversity, polarization diversity or screen-based solutions. As discussed by Joseph W. Goodman in “Speckle phenomena in optics: theory and applications”, Englewood, Colo.: Roberts & Co., ©2007, attempts have been previously made to provide various solutions on de-speckling. Some approaches have become conventional practices in the industry, for example:

(1) using several lasers as the illumination light source;

(2) illuminating the light source from different angles;

(3) introducing wavelength diversity in the illumination;

(4) using different polarization states of laser;

(5) using a screen specially designed to minimize the generation of speckle, for example, a moving screen; and

(6) using a rotating diffuser.

Theses proposed solutions for speckle reduction have various strengths and weaknesses. Some requires an additional component like diffuser to be provided in the system and may make it even more challenging in miniaturizing the systems, for example, a diffuser directing the diffused laser light to a rocking mirror for speckle reduction as described in the U.S. Pat. No. 4,155,630 titled “Speckle Elimination By Random Spatial Phase Modulation”, or a spinning diffuser as described in the U.S. Pat. No. 5,313,479 titled “Speckle-free Display System using Coherent Light”.

Use of additional components may further contribute to difficulties in integrating the speckle reduction scheme into existing systems, while some even require external moving actuators which lead to additional power consumption. For example, the European Patent Application EP1,949,166 describes the use of actuator pads to drive an Al-coated micromachined membrane in the direction towards these actuator pads; the Al-coated micromachined membrane deforms a mirror which scatters light to reduce speckle. Such an actuation mechanism also confines the mirror deformation along one single direction.

Some proposed solutions require a moving screen which not only makes image display impossible on any still screen but also may become problematic to find an appropriate means to move the screen as the screen size increases. For example, it will be difficult for the transducer described in the U.S. Pat. No. 5,272,473 entitled “Reduced-Speckle Display System” to work for a large screen where the transducer is required to be coupled to a display screen to set up surface acoustic waves which traverse the display screen. There is another type of moving display described in U.S. Pat. No. 6,122,023 entitled “Non-speckle Liquid Crystal Projection Display” which provides a layer of liquid crystal molecules vibrating slightly at a frequency higher than 60 Hz in the display screen.

There remains a need in the art to provide speckle reduction for displays.

### SUMMARY OF THE INVENTION

An object of the present invention is to provide a moving membrane capable of effectively suppressing speckle noise using a simple optical system. The moving membrane vibrates at a higher frequency than the scanning frequency of the scanning mirror, for example, at a frequency which is high enough to generate an enlarged spot before the scanning mirror moves to generate another point in a 2D image. The present invention provides a MEMS (microelectromechanical system) device which has a membrane attached to a stationary frame. The membrane is configured to refract incident laser beams at different refraction angle temporally upon the vibration of the membrane. As each laser beam is refracted to travel in various slightly different paths over time, a larger laser spot size is generated on a plane instead of having one single, coherent laser spot after the laser spot from laser beams travelling along different paths overlap upon arrival on a plane at different time.

During operation, the membrane vibrates in various directions and the vibration causes incident laser beams hitting at periodically different locations of the membrane and consequently these laser beams are refracted by the membrane with distinct refraction angles temporally. These temporally incoherent refracted laser beams can then be utilized as a light source for generating an image with suppressed laser speckle effect.

The MEMS device provided by the present invention can be manufactured in a batch fabrication process which lowers the device unit cost. The MEMS fabrication technology results in a small device form factor which is highly desirable in many portable consumer electronic products.

Furthermore, high optical efficiency can be achieved by using the MEMS device according to the present invention which works without any diffuser and the reflective surface profiles provided by the MEMS device of the present invention are more controllable.

Since no external moving actuator or diffuser is needed, the present invention has low power consumption.

The MEMS device according to the present invention allows a controllable vibration amplitude or frequency so that parameter tuning can be performed to attain an optimized laser de-speckle effect. Different applied voltages and frequencies are used to optimize the performance of de-speckling. The vibration amplitude is adjusted by, for example, varying the input driving voltage to the MEMS device while the vibration frequency is tuned by designing the dimensions of the actuating parts of the MEMS device, for example, by changing torsional bar dimensions. The present invention provides a robust structure with a similar process flow to the MEMS scanning mirror fabrication, enabling further integration of the de-speckle device into the MEMS scanning mirror.

One aspect of the present invention is to provide a MEMS device for reducing speckle effect by broadening a laser spot size in a laser scanning projection display, which includes an incident laser beam having a first cross-sectional laser spot size; a membrane configured to change shape temporally such that one or more laser beams are refracted by the membrane at distinct refraction angles such that a time average of the refracted laser beams creates a second cross-sectional laser spot size different from the first cross-sectional laser spot size; and one or more actuators capable of changing the shape of the membrane temporally.

Another aspect of the invention is to move the membrane by a plurality of actuators which is an array of electrodes arranged on the MEMS over a region being covered by the membrane.

According to a further aspect of the invention is to deform the membrane by one or more oscillating actuators, each of which supports each end of the membrane and oscillates temporally.

Another aspect of the present invention is to provide at least a region of the surface of the MEMS device being covered by the membrane which is densely patterned with a plurality of mirrors.

One aspect of the present invention is to have the membrane coated with a layer of electrically conductive thin film.

According to a further aspect, the top of the MEMS device is coated with a scattering layer and the surface of the scattering layer is coated with a reflective coating. Alternatively, the surface of the scattering layer is roughened, is a patterned film of dielectric, or has a polymeric structure on its surface.

Another aspect of the present invention is to provide a reflective coating on the scattering layer. In this case, the scattering layer is made of an inhomogeneous phase-changing polymer.

One aspect of the present invention is to provide an optical system using the MEMS device as described above, which includes an illumination source emitting one or more laser beams, one or more laser beams being transmitted onto the periodically vibrating membrane of the MEMS device and refracted thereby; and a biaxial MEMS mirror receiving the laser beams refracted by the MEMS device and reflecting the laser beams in a scanning manner to generate an image on a screen.

Another aspect of the present invention is to provide an optical system using the MEMS device as claimed in claim 1 as described above, which includes an illumination source emitting one or more laser beams, one or more laser beams being transmitted onto the membrane of the MEMS device and refracted thereby; at least one additional MEMS device, the MEMS device being the MEMS device of claim 1, is positioned to receive and refract the laser beams departing from the MEMS device; and a biaxial MEMS mirror receiving the laser beams from the additional MEMS device and reflecting the laser beams in a scanning manner to generate an image on a screen.

Other aspects of the present invention are also disclosed as illustrated by the following embodiments.

### BRIEF DESCRIPTION OF THE DRAWINGS

These and other objects, aspects and embodiments of this claimed invention will be described hereinafter in more details with reference to the following drawings, in which:

FIG. 1 depicts the scattering of a laser beam on a surface.

FIGS. 2a, 2b and 2c depict a transverse wave propagating through a membrane according to one embodiment of the present invention.

FIGS. 3a and 3b depict a MEMS device with a membrane through which a transverse wave is propagating according to one embodiment of the present invention.

FIGS. 4a, 4b, 4c and 4d depict a MEMS device with a membrane through which a transverse wave is propagating according to one embodiment of the present invention.

FIGS. 5a and 5b depict a MEMS device with a membrane at various states of deformation according to one embodiment of the present invention.

FIGS. 6a, 6b, 6c and 6d depict a MEMS device with a membrane at various states of deformation according to one embodiment of the present invention.

FIG. 7 depicts a MEMS device with a membrane according to one embodiment of the present invention.

FIGS. 8a and 8b depict a MEMS device with a membrane at various states of deformation according to one embodiment of the present invention.

FIG. 9a depicts a roughened scattering layer on top of a MEMS device according to one embodiment of the present invention.

FIG. 9b depicts a patterned scattering layer on top of a MEMS device according to one embodiment of the present invention.

FIG. 9c depicts a scattering layer of inhomogeneous materials on top of a MEMS device according to one embodiment of the present invention.

FIG. 9d depicts a scattering layer of polymeric structures on top of a MEMS device according to one embodiment of the present invention.

FIG. 10 depicts an illustration of the effect of de-speckling by one embodiment of the present invention.

FIGS. 11a and 11b depict a schematic block diagram of an optical system using at least one MEMS device with membrane according to certain embodiments of the present invention.

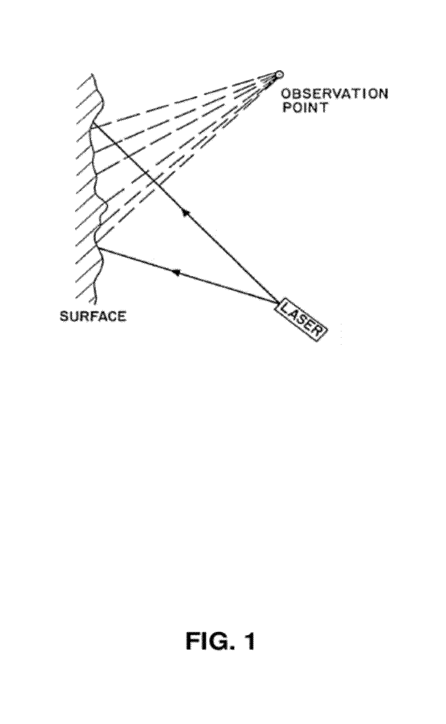

### DETAILED DESCRIPTION OF THE INVENTION

A MEMS device has at least one movable component. In one embodiment, the movable component is a membrane. The membrane has a certain degree of flexibility allowing the membrane to be deformed and change shapes. The membrane may reflect, refract, polarize or scatter light such as laser beams and may be made of materials such as thin film or conductive film (e.g. ITO).

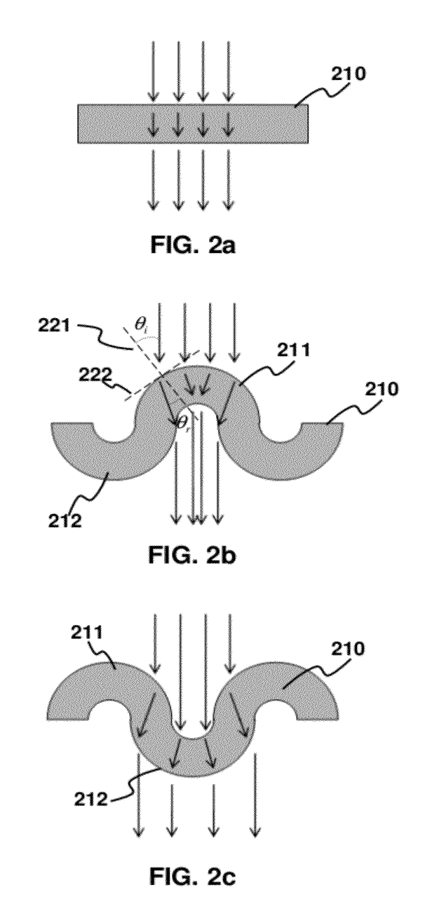

FIGS. 2a, 2b and 2c depict a transverse wave propagating through a membrane according to one embodiment of the present invention. In this embodiment, light rays such as laser beams travel through the membrane and get refracted.

According to the Snell's law, the refraction angle θᵣ is given by the following equation (1):

$$\frac{sin {θ}_{i}}{sin {θ}_{r}} = \frac{{n}_{i}}{{n}_{r}} \qquad ( 1 )$$

where θᵢ is the incidence angle, nᵢ is the refractive index of a first medium where an incident ray is travelling before it reaches a second medium with the refractive index nᵣ. The incident ray is refracted by the second medium and travels in the second medium at the refraction angle θᵣ.

FIG. 2a shows the membrane 210 is at rest and remains to be substantially flat. Light rays reach the substantially flat surface of the membrane 210 and enter into the membrane 210. As shown in the FIG. 2a, the incidence rays are normal to the interface between the membrane 210 and a first medium before the entry of light rays into the membrane 210 so that the incidence angle is equal to zero. According to the equation (1), the refraction angle is equal to zero. As refraction occurs when light rays travel from one medium to another medium which has a different refraction index, the light rays are refracted again when they leave the membrane 210 into a second medium. Given that the incidence angle of the incidence rays at the interface between the membrane and the second medium remains to be zero, the refraction angle upon the departure of the membrane 210 is equal to zero. Therefore, the propagation direction of the light rays remains the same before and after passing the membrane 210. In other words, the light rays travel straight through the membrane 210.

FIG. 2b shows the membrane 210 is moved in a way that there is a transverse wave propagation across the membrane 210. The wave propagation generates ripples on the membrane 210. Various crests 211 and troughs 212 are formed on the membrane 210. For incident rays travelling in the same direction in parallel paths before reaching the membrane 210, they reach a crest 211 on the membrane 210 at different time and at different incidence angles because their paths intersect with the membrane 210 at different locations. Consequently, incident rays are refracted with different refraction angles at different locations of the crest 211 when passing through the membrane 210 because of the different incidence angles. In this embodiment, both the first medium before entry into the membrane 210 and the second medium after departure from the membrane 210 have refractive indexes larger than that of the membrane 210. In other words, the light rays travel at a higher speed in each of the first and the second media than in the membrane 210.

Upon entry into the membrane 210, the light rays are deflected towards the normal of the interface between the first medium and the membrane 210. For example, one of the rays is deflected towards the normal 221 to the interface (with a tangent 222) between the first medium and the membrane 210. Since each normal at different parts of the crest 211 are pointing towards the centre of curvature of the crest 211, each of the initially parallel light rays is refracted to travel in a path more directed to the centre of curvature. As a result, the crest 211 of the membrane 210 provides an effect of focusing like a convex lens. The more the membrane 210 is curved, the more focused the light rays will be. After entering the crest 211 of the membrane 210, the light rays travel in the membrane 210 along paths converging towards one another. The thicker the membrane 210, the longer the distance the light rays travel in the membrane 210, resulting in the light rays moving closer together. Therefore, the focusing effect by the crest 211 depends on factors such as the degree of curvature, the refractive index and the thickness of the membrane 210.

When departing from the membrane 210 to the second medium, the light rays are refracted again. Since the light rays are travelling from a medium with a lower refractive index to a medium with a higher refractive index, the light rays are deflected away from the normal when crossing the interface between the membrane 210 and the second medium. In other words, the incidence angles are smaller than the refraction angles. Since each normal at different parts of the crest 211 are pointing towards the centre of curvature of the crest 211, deflecting away from the normal makes the light rays less focused, that is, more dispersed.

FIG. 2c shows the case opposite to the one shown in FIG. 2b. Instead of reaching the crest 211 of the membrane 210, the light rays reach the trough 212 of the membrane 212. Therefore, light rays are incident on membrane 210 at a concave surface of a trough 212 rather than a convex surface in the case of a crest. Each normal to the interface between the first medium and the membrane 210 radiates from a centre of curvature and the light rays fan out across the membrane 210. When the lights rays are refracted upon entry into the membrane 210, they are deflected towards the normals. Therefore, the light rays travel in the membrane 210 in paths with diverging directions and the trough 212 of the membrane 210 provides a dispersing effect to the light rays.

When departing from the membrane 210 into the second medium, the light rays are refracted towards the normal to the interface between the membrane 210 and the second medium.

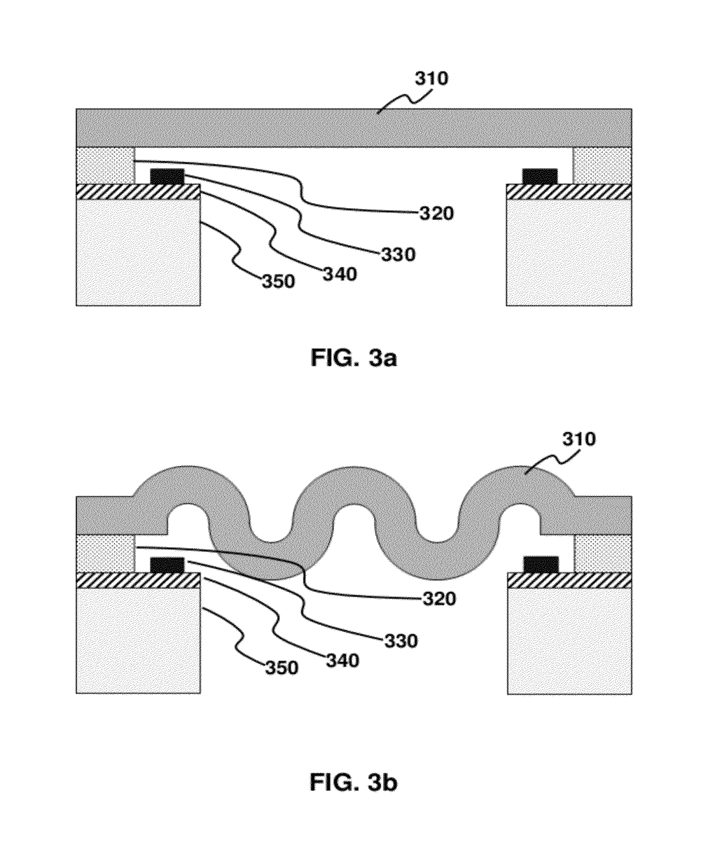

FIGS. 3a and 3b depict a MEMS device with a membrane through which a transverse wave is propagating according to one embodiment of the present invention. The MEMS device is transmissive by allowing a laser beam to pass through it. The movement of the membrane 310 is generated by a MEMS device. Each end of the membrane 310 is supported by an actuator 320. Each actuator 320 is arranged on the surface 340 of a substrate 350. On the surface 340, there is another actuator 330 in addition to the actuator 320. The actuator 320 also performs a function as a spacer so that the movement of the membrane 310 will not be hindered by other components of the MEMS device. There can be one or more actuators, each of which supports each end of the membrane 310. For the movement of membrane, the actuator 320 provides one degree of freedom while the actuator 330 provides another degree of freedom. The more actuators are provided, the more degrees of freedom in membrane movement can be achieved.

Both actuators 320 and 330 can provide actuation, for example, in form of electrostatic force, piezoelectric force or magnetic force. Transverse waves can be generated on the membrane 310 through the oscillation of the actuators 320 and/or 330 as shown in FIG. 3b. The actuator 320 at one end of the membrane 310 oscillates while the actuator 320 at the other end remains stationary. Alternatively, the actuators 320 at both ends of the membrane 310 oscillate so that transverse waves travel in opposite directions are generated and superimpose with one another. The actuator 320 oscillates and moves one end of the membrane 310 in vertical directions, i.e., up and down. Or the actuators 320 are arranged at the four corners of the membrane 310. Or the actuator 320 can be a plurality of discrete actuators which actuate at different times and oscillate at different amplitudes and frequencies. Or the actuator 320 can be a bar-shaped which is arranged along one edge of the membrane 310 and another bar-shaped actuator 320 is arranged along the opposite edge of the membrane 310. The bar-shaped actuator 320 is tilted with one end oscillating at a larger amplitude than the other end does.

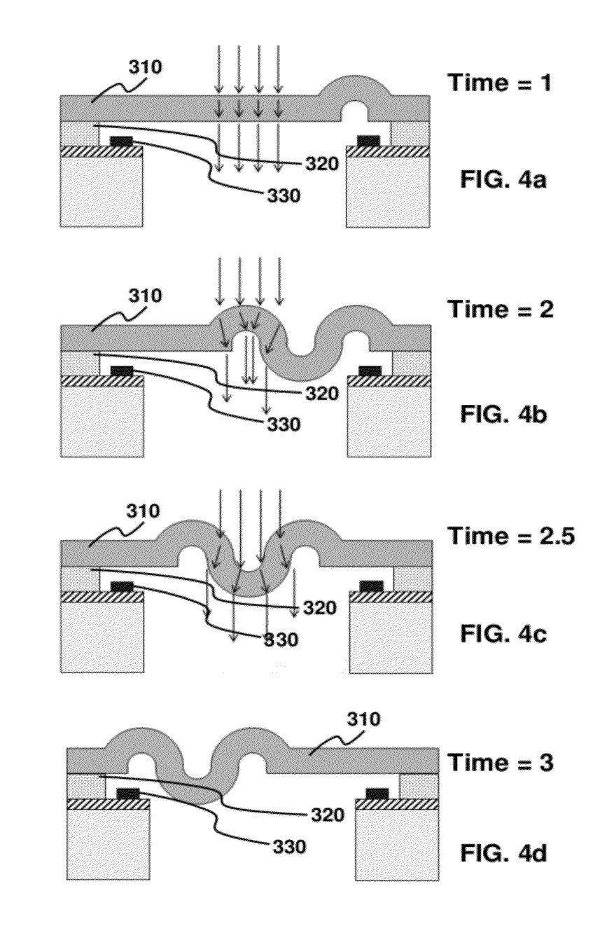

FIGS. 4a, 4b, 4c and 4d depict a MEMS device with a membrane through which a transverse wave is propagating according to one embodiment of the present invention. At a time instance, for example, a time interval is equal to 1 second, actuator 320 and actuator 330 start oscillating to generate a transverse wave. Initially the membrane 310 has a substantially flat surface stretching between actuators 320 and has its two ends supported by the actuators 320 at opposite ends. When the laser beam reaches the membrane 310 in a direction perpendicular to the surface of the membrane 310, the laser beam passes through the membrane 310 along a straight path without being deflected.

At another time instance, for example, the time interval is equal to 2 seconds, the laser beam intersects the membrane 310 at a crest of the transverse wave travelling in the membrane 310. The laser beam is converged at the crest of the transverse wave and becomes more focused.

At another time instance, for example, when the time interval is equal to 2.5 seconds, the laser beam intersects the membrane 310 at a trough of the transverse wave travelling in the membrane 310. The laser beam diverges at the trough of the transverse wave and becomes more dispersed. In the meantime, the oscillations of the actuators 320, 330 stop and no additional crest or trough will be generated.

The transverse wave keeps travelling in the membrane 310 from one side to the other. When the time interval is equal to 3 seconds, the laser beam hits another crest and converges into a more concentrated laser spot as shown in FIG. 4d. Subsequently, after the transverse wave ceases, the membrane 310 returns to a substantially flat surface and the laser beam will pass through the membrane 310 in a straight path.

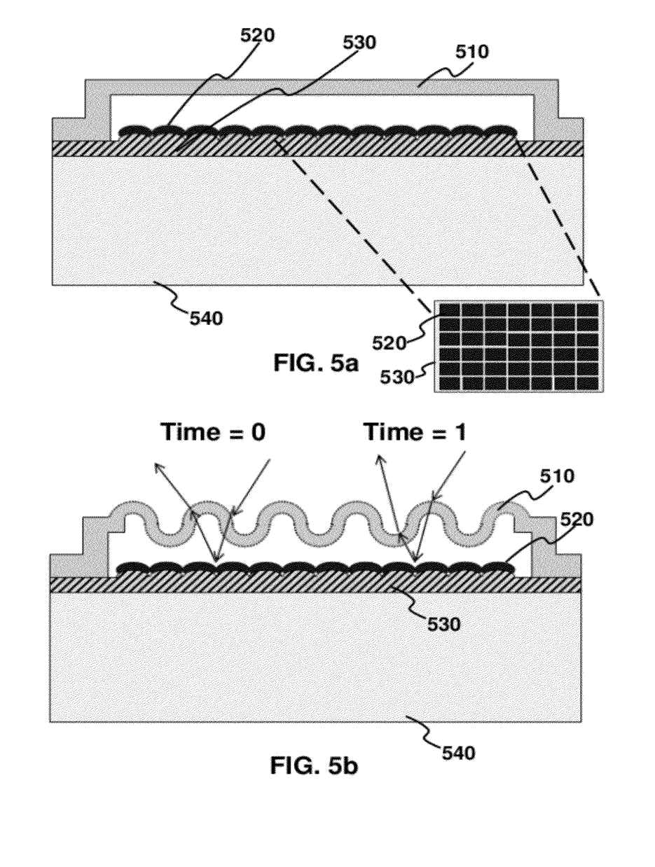

FIGS. 5a and 5b depict a MEMS device with a membrane at various states of deformation according to one embodiment of the present invention. The MEMS device has a membrane 510 covering the top of the MEMS device. Some examples of the membrane 510 include an electrically conductive transparent film such as ITO (Indium Tin Oxide). Between the membrane 510 and the top of the MEMS device, there is a cavity. Before reaching the top of the MEMS device and getting scattered, the laser beam travels in the medium of the cavity. A scattering layer 530 is coated on the top of the substrate of MEMS device. At least a region of the scattering layer 530 is densely patterned with an array of tiny mirrors as shown in FIG. 5a. Each tiny mirror has a top reflective coating 520 on its surface to make the tiny mirror reflective so that the laser beam is reflected by these tiny mirrors when reaching them.

The membrane 510 is deformed by a plurality of electrodes (not shown) arranged beneath the membrane 510. Each electrode is switched on at different times to apply a voltage between the membrane 510 and the electrode. The deformation pattern depends on factors such as the locations of the electrodes, the density of electrodes and how each electrode is switched. In one embodiment, the electrodes are switched in a way that a curvy pattern is formed on the membrane 510 as shown in FIG. 5b. This curvy or wavy pattern is changed when varying how the electrodes are charged and/or the membrane 510 is charged. For example, the electrodes can be oppositely charged in alternate rows so that the membrane 510 is deformed with alternate ups and downs. The membrane 510 remains stationary at nodes or regions where the membrane 510 is not affected by the electrodes, for example, where no electrode is present underneath the membrane 510 or along the gaps between the electrodes. Electrodes are one example of the actuator and other examples may include actuation mechanisms using magnetic force.

Due to the deformation of the membrane 510, light is diffracted differently temporally such that the light crossing the membrane 510 reaches different locations of a plane and overlaps together to create a larger time-average light spot. For example, the laser beam reaches different parts of the membrane 510 at different times and gets through the membrane 510 at different incidence angles at different times. After passing through the membrane 510, the laser beam is further scattered by the scattering layer. The scattered laser beam will pass through the membrane 510 again and reach different parts of the membrane 510. Various degrees of convergence or divergence are provided to the membrane 510. Therefore, when the laser beam is reflected by the mirror array 520 and leaves the MEMS device, laser beams at different times will have varying departure angles for their paths departing the MEMS device.

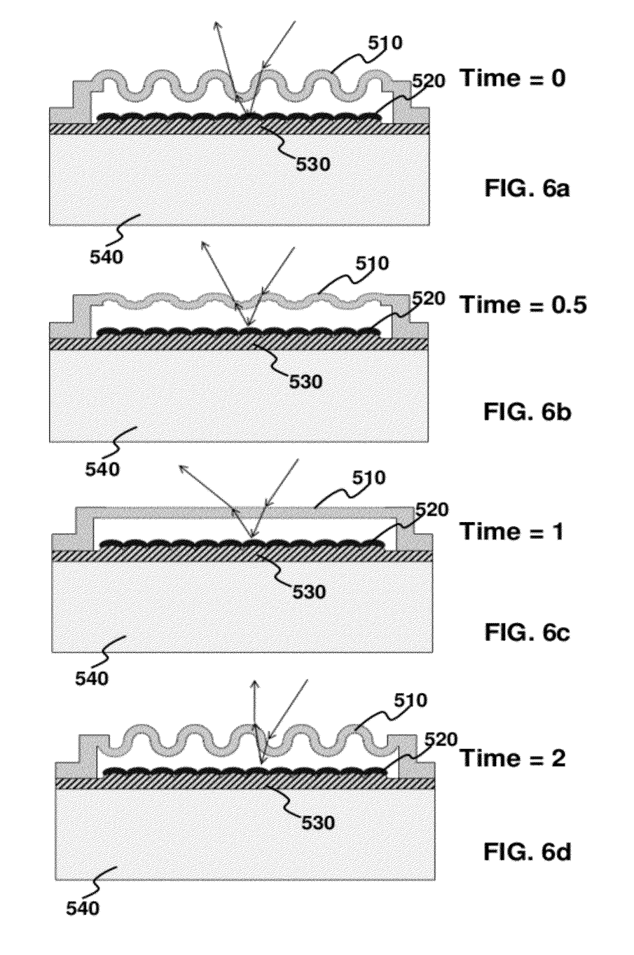

FIGS. 6a, 6b, 6c and 6d depict a MEMS device with a membrane at various states of deformation according to one embodiment of the present invention. Under the influence of electrodes, the membrane 510 is deformed. In one example, the magnitude of the deformation along vertical directions reaches its maximum at a time interval equal to 0 second as shown in FIG. 6a. The laser beam is refracted by a crest of the membrane 510 after passing through the membrane 510. Subsequently the laser beam is scattered by the reflective coating 520 over the scattering layer 530. When being reflected away from the MEMS device, the laser beam reaches a crest on the membrane 510 and is further refracted after crossing the membrane 510.

As shown in FIG. 6b at a time interval equal to 0.5 sec, the magnitude of the deformation along vertical direction diminishes as the electrostatic forces generated between the membrane 510 and the electrodes decreases. The protrusions on the membrane 510 become flattened and the degree of curvature for each crest and trough is reduced. The laser beam is refracted by a lesser degree when compared with earlier time instances when crossing the membrane 510. Subsequently the laser beam is scattered by the reflective coating 520 over the scattering layer 530. The scattering angles may be different from those at previous time instances because the difference in the refraction angles and changes the path of the laser beam and the location of the scattering surface on the scattering layer 530. When being reflected away from the MEMS device, the laser beam reaches a crest on the membrane 510 and is further refracted after crossing the membrane 510.

At a time interval equal to 1 second, the membrane 510 is restored to its resting position as shown in FIG. 6c instead of being deformed by the electrodes. The paths of the laser beam change upon the transmission through the membrane 510 by refraction, upon the reflection by the scattering layer 530 and further upon departure from the membrane 510 by refraction. Even though the laser beam reaches the MEMS device from the same direction, the incidence angles of the laser beam at the membrane 510 differ from previous ones when there is deformation of the membrane 510 so that the refraction angles varies, leading to variations in the paths of laser beams when compared with previous time instances.

At a time interval equal to 2 seconds, the membrane 510 is deformed in a way that the laser beams reach a trough of the membrane as shown in FIG. 6c and the departing laser beams from the MEMS device take a path different from prior cases.

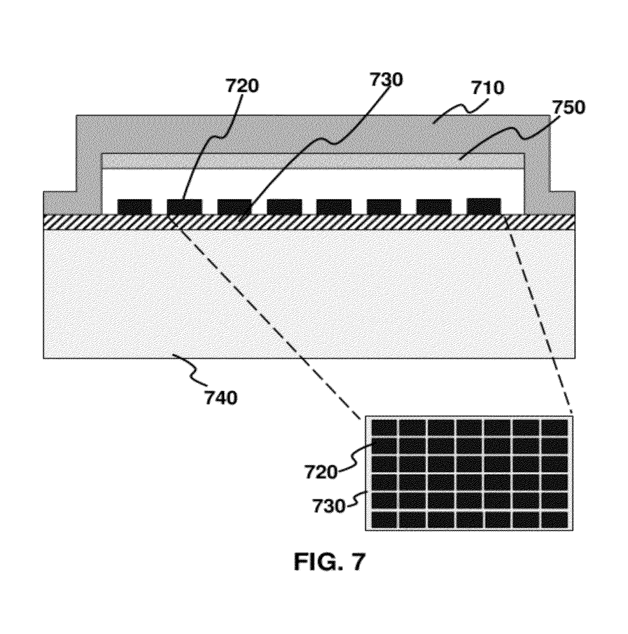

FIG. 7 depicts a MEMS device with a membrane according to one embodiment of the present invention. The membrane 710 is a thick transparent film with an electrically conductive transparent film 750 coated underneath. Some thick transparent films have a thickness over a micron. Some examples of the thick transparent films include polydimethylsiloxane (PDMS), parylene polymeric material, SU-8 photoresist and various other photoresists. Some examples of the electrically conductive transparent film 750 include ITO. The membrane 710 forms a cover on top of the MEMS device. A chamber is formed between the membrane 710 and the top of the MEMS device. A scattering layer 730 is coated on the top surface of the MEMS device and a substrate 740 is underneath of the scattering layer 730. An array of scattering mirrors 720 is densely arranged on the scattering layer 730.

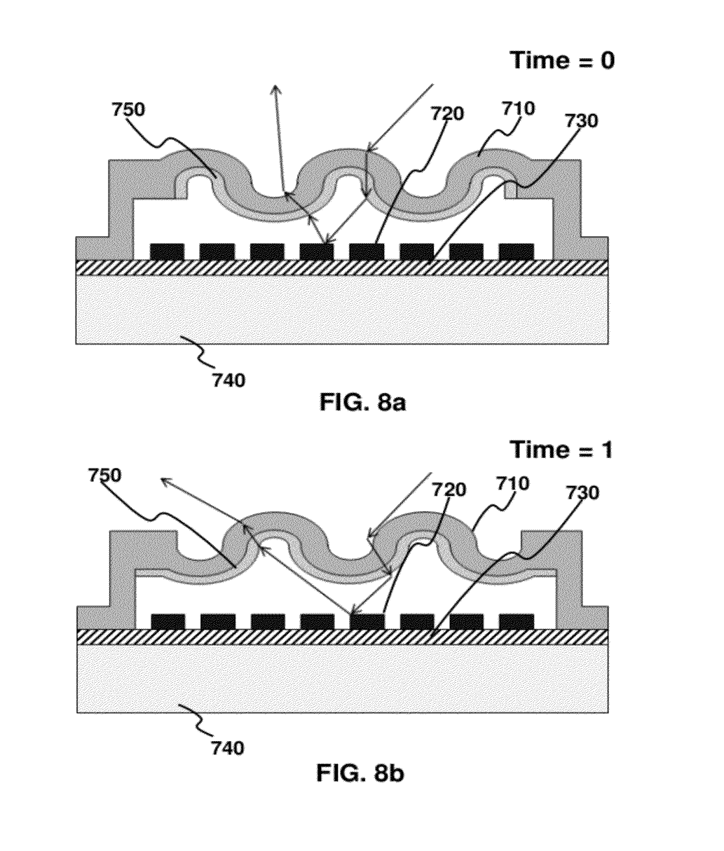

In this embodiment, the membrane 710 is thicker than the ones shown in FIGS. 6a to 6d. As shown in FIG. 8a, the laser beams travels through the membrane 710 for a longer distance and are refracted twice at both the upper and lower boundaries of the membrane 710. Further refraction may occur at the interface between the membrane 710 and the film 750. A plurality of electrodes (not shown) are fabricated on the surface of the MEMS device in a region covered by the membrane 710. The electrodes are charged at different polarities when being switched on and are capable of generating electrostatic force to deform the membrane 710 by moving the electrically conductive thin film 750 towards or away from the top of the MEMS device.

FIGS. 8a and 8b depict a MEMS device with a membrane at various states of deformation according to one embodiment of the present invention. At a time interval equal to zero, the membrane 710 is deformed by electrodes positioned beneath the membrane as shown in FIG. 8a, forming various crests and troughs on the membrane 710 as if a transverse wave or a standing wave is generated on the membrane 710. The deformation makes the membrane 710 vibrate and provides a vibrating medium for laser beams to traverse. The incident laser beam reaches a crest and is refracted by the membrane 710. Subsequently, the laser beam reaches the reflective mirrors 720 and will be reflected away from the MEMS device with scattering. The departing laser beam travels through the membrane 710 and the electrically conductive thin film 750 again and gets refracted.

FIG. 8b shows the laser beam travelling towards the MEMS device at a time interval equal to 1 second, the membrane 710 is deformed in a way that the waveform is 180 degrees out of phase to the waveform as shown in FIG. 8a. The laser beam is incident to the membrane 710 at a region near to a trough. This gives the laser beam a different path change when compared with the case as shown in FIG. 8a because the refraction angles are different. Consequently, the laser beam is refracted differently temporally and will have its travelling directions deflected for a number of times. Phase changes also occur within the membrane 710 due to different path lengths.

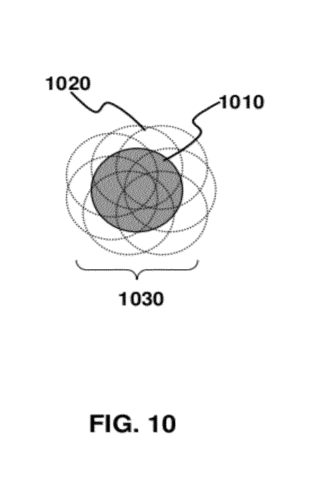

Instead of being reflected as one single spot 1010 onto a screen or, in other embodiments, onto another reflector with movable or vibrating reflecting surface such as the ones as disclosed in the co-pending US Patent application with the attorney docket number P3448US00, a mirror or a biaxial MEMS mirror for further reflection and scattering, each reflected laser beam generates a larger spot 1030 which is an average of several original smaller spots 1020 reflected onto different locations of the screen at different times as depicted in FIG. 10. The larger spot 1030 is generated fast enough such that only the large spot 1030 is perceptible by an observer viewing the image on the screen.

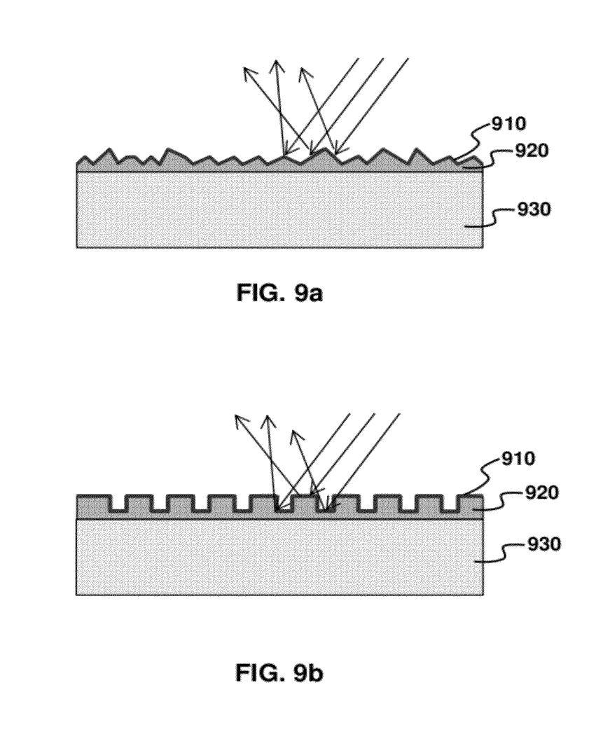

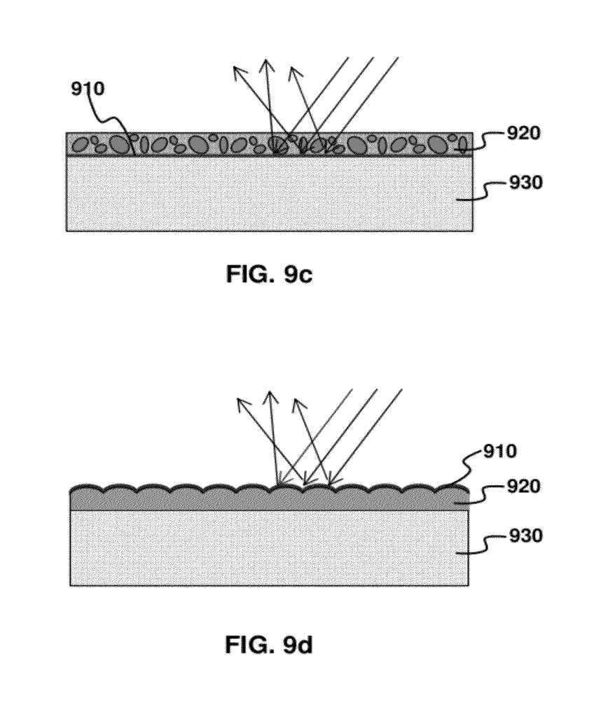

In one embodiment, a scattering layer is applied to the top of the mirror or the MEMS device to increase the temporal distinctiveness in the reflection angles. The scattering layer 920 has its surface roughened or polished in some embodiments and has a reflective coating 910 coated on the polished surface of the scattering layer 920 as depicted in FIG. 9a. Some examples of the reflective coating 910 include gold and aluminum. As an alternative of applying a scattering layer 920, the rough surface can be attained by polishing the top of the MEMS device 930 and subsequently applying a reflective coating 910 thereon to make the top of the MEMS device 930 reflective.

As depicted by FIG. 9b according another embodiment of the present invention, the scattering layer 920 is a patterned film of dielectric such as silicon oxide SiO₂ and silicon nitride Si₃N₄ and has a reflective coating 910 coated on the patterned surface of the scattering layer 920. As an alternative of applying a scattering layer 920, the patterned surface can be attained by patterning the top of the MEMS device 930 and subsequently applying a reflective coating 910 thereon to make the top of the MEMS device 930 reflective.

As depicted by FIG. 9c according another embodiment of the present invention, a reflective coating 910 is coated on the top of the MEMS device 930 and subsequently a scattering layer 920 of inhomogeneous phase-changing polymer such as liquid crystals is applied on the top of the reflective coating 910.

As depicted by FIG. 9d according another embodiment of the present invention, the scattering layer 920 of polymeric structure is applied to the top of the MEMS device 930 and has a reflective coating 910 coated on the polymeric structure of the scattering layer 920. Some examples of the scattering layer 920 of the polymeric structure include SU-8 photoresist, parylene, photoresist, and PDMS.

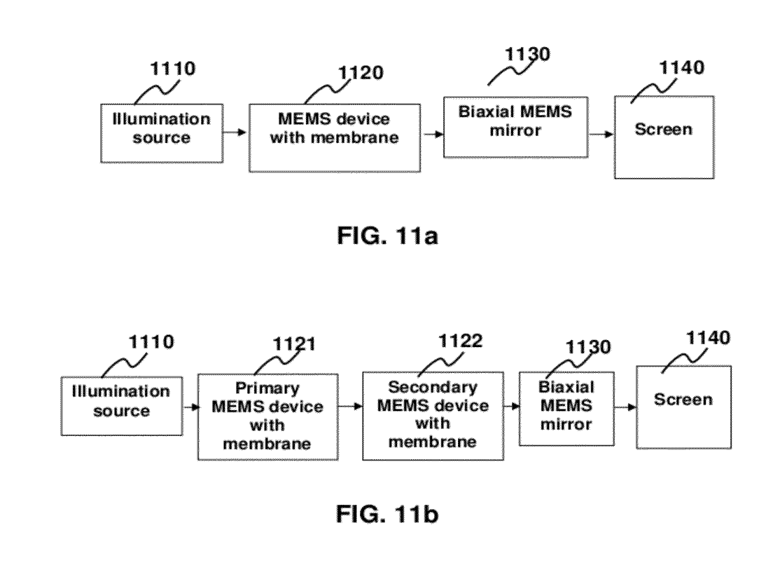

FIG. 11a shows a schematic block diagram of an optical system using a MEMS device with a membrane according to one embodiment of the present invention. The optical system includes a MEMS device with membrane 1120 which receives laser beam from an illumination source 1110. The MEMS device with membrane 1120 may be the one which allows a laser beam to pass through itself after refraction as a departing laser beam, or the one which reflects or scatters the laser beam as a departing laser beam. The biaxial MEMS mirror 1130 uses the departing laser beam to perform laser scanning with its rotations along the two orthogonal axes to generate an image on a screen 1140. The optical system may further include various components such as mirrors and lenses at various points of the travelling path of the laser beam.

FIG. 11b shows a schematic block diagram of an optical system using one or more MEMS devices with membranes according to one embodiment of the present invention. To further increase the distinctiveness in the travelling paths of laser beams and the phase differences to the laser beams, one or more MEMS devices with membranes are provided such that a larger laser spot is generated after the treatment by the MEMS devices. Upon the treatment by a MEMS device, the laser beams are refracted or reflected/scattered. The laser beams from an illumination source 1110 are treated by a primary MEMS device with membrane 1121 before they are further treated by a secondary MEMS device with membrane 1122. Various embodiments of MEMS devices with membranes as disclosed above can be used as the primary MEMS device with membrane 1121 and the secondary MEMS device with membrane 1122 respectively. For example, the MEMS device with membrane 1121 or 1122 is a MEMS device which refracts the laser beams by its membrane. More than one MEMS devices with membrane can be used as the secondary MEMS device 1122 with membrane so that the departing laser beams from the primary MEMS device 1121 reaching one of the secondary ones will either be refracted or scattered. One of the MEMS devices with membrane 1121 or 1122 can be replaced by MEMS devices with a movable or vibrating surface so that the vibration movements by the MEMS devices disperse the laser beams Apart from other lenses and mirrors in the optical system, a biaxial scanning MEMS mirror 1130 is provided to reflect the laser in a scanning manner with its rotational motions along two substantially perpendicular axes. Consequently, the laser from an illumination source 1110 reaches the screen 1140 with reduced speckling effect.

While particular embodiments of the present invention have been illustrated and described, it is understood that the invention is not limited to the precise construction depicted herein and that various modifications, changes, and variations are apparent from the foregoing description. Such modifications, changes, and variations are considered to be a part of the scope of the invention as set forth in the following claims

What is claimed is:

1. A MEMS device for reducing speckle effect by broadening a laser spot size in a laser scanning projection display, comprising:
a membrane configured to change shape temporally such that one or more incident laser beams having a first cross-sectional laser spot size are refracted by the membrane at distinct refraction angles such that a time average of the refracted laser beams creates a second cross-sectional laser spot size different from the first cross-sectional laser spot size; and
one or more actuators capable of changing the shape of the membrane temporally.

2. The MEMS device as claimed in claim 1, wherein:
the actuator is an array of electrodes arranged on the MEMS device over a region being covered by the membrane.

3. The MEMS device as claimed in claim 1, wherein:
each of the actuators supports each end of the membrane and oscillates temporally.

4. The MEMS device as claimed in claim 1 wherein:
at least a region of the surface of the MEMS device being covered by the membrane is densely patterned with a plurality of minors.

5. The MEMS device as claimed in claim 1 wherein:
the membrane is coated with a layer of electrically conductive thin film.

6. The MEMS device as claimed in claim 1 wherein:
at least a region of the surface of the MEMS device being covered by the membrane is coated with a scattering layer.

7. The MEMS device as claimed in claim 5 wherein:
the surface of the scattering layer is coated with a reflective coating.

8. The MEMS device as claimed in claim 5 wherein:
the surface of the scattering layer is roughened.

9. The MEMS device as claimed in claim 5 wherein:
the scattering layer is a patterned film of dielectric.

10. The MEMS device as claimed in claim 5 wherein:
the scattering layer has a polymeric structure at least on the surface thereof.

11. The MEMS device as claimed in claim 5 wherein:
a reflective coating is provided between the top of the scattering layer.

12. The MEMS device as claimed in claim 10 wherein:
the scattering layer is made of inhomogeneous phase-changing polymer.

13. An optical system using the MEMS device as claimed in claim 1 further comprising:
an illumination source emitting one or more laser beams, one or more laser beams being transmitted onto the periodically vibrating membrane of the MEMS device and refracted thereby; and
a biaxial MEMS mirror receiving the laser beams refracted by the MEMS device and reflecting the laser beams in a scanning manner to generate an image on a screen.

14. An optical system using the MEMS device as claimed in claim 1 further comprising:
an illumination source emitting one or more laser beams, one or more laser beams being transmitted onto the membrane of the MEMS device and refracted thereby;
at least one additional MEMS device, the MEMS device being the MEMS device of claim 1, positioned to receive and refract the laser beams departing from the MEMS device; and
a biaxial MEMS mirror receiving the laser beams from the additional MEMS device and reflecting the laser beams in a scanning manner to generate an image on a screen.
